(19) United States
(12) Patent Application Publication
(10) Pub. No.: US 2012/0106148 A1
(43) Pub. Date: May 3, 2012

(54) LED LIGHT SYSTEM

(76) Inventor: Niranjan B. De Silva, Long Beach, CA (US)

(21) Appl. No.: 13/252,071

(22) Filed: Oct. 3, 2011

Related U.S. Application Data
(60) Provisional application No. 61/389,646, filed on Oct. 4, 2010.
(60) Provisional application No. 61/542,420, filed on Oct. 3, 2011.

(51) Int. Cl. F21V 5/04; F21V 29/00

(52) U.S. Cl. 362/235; 362/249.02

(57) ABSTRACT

An exemplary embodiment of a light head includes a housing structure, a light source, and a lens or transparent window through which light emitted by the head light source is passed. The head further includes an electrical module, and a plurality of separate light emitting diode (LED) modules as the light source, connected to the electrical module to provide electrical power to the LED modules. The LED modules are supported in the housing structure by a bracket system. An exemplary application is for a streetlight head unit.

### CROSS-REFERENCE TO RELATED APPLICATION

This application claims priority from provisional application number 61/389,646, filed Oct. 4, 2010, the entire contents of which application is incorporated herein by this reference. The entire contents of provisional application 61/542,420, Light System for Retrofit and Other Applications, filed Oct. 3, 2011, is also incorporated herein by this reference.

### BACKGROUND

This invention relates to lighting applications such as street or area lighting, and in an exemplary embodiment to a streetlight head employing LED light sources.

### BRIEF DESCRIPTION OF THE DRAWINGS

Features and advantages of the disclosure will readily be appreciated by persons skilled in the art from the following detailed description when read in conjunction with the drawing wherein:

FIG. 1 is an isometric, partially broken-way view of an exemplary embodiment of a streetlight head employing a set of light-emitting-diodes as an illumination source.

FIG. 2 is a cutaway end view taken along line 2-2 of FIG. 1. FIG. 2A is an isometric view of an exemplary embodiment of a bracket for the streetlight head of FIG. 1. FIG. 2B is a front view of the bracket of FIG. 2A.

FIG. 3 is a simplified diagrammatic view of an LED strip employed in the system of FIG. 1.

FIG. 4 is a diagrammatic cutaway view illustrating an alternate embodiment of a bracket system for the streetlight head. FIG. 4A is an isometric view of the primary bracket of the bracket system of FIG. 4. FIGS. 4B and 4C are front and side views of the bracket system of FIG. 4. FIG. 4D is an isometric view of an exemplary embodiment of a pivot bracket of the bracket system of FIG. 4.

FIG. 5 is a simplified electrical schematic block diagram of the system of FIG. 1.

FIG. 6 is an isometric partial view of another embodiment of a streetlight head using four LED modules, with one module removed for illustration.

FIG. 7 is a diagrammatic end view of the head embodiment of FIG. 6.

FIG. 8 is a diagrammatic exploded isometric view of an LED module of FIGS. 6 and 7.

FIG. 9 illustrates a simplified electrical schematic block diagram for the system of FIG. 6.

FIG. 10 illustrates standoff bosses for attaching the bracket structures to the head housing.

### DETAILED DESCRIPTION

In the following detailed description and in the several figures of the drawing, like elements are identified with like reference numerals. The figures are not to scale, and relative feature sizes may be exaggerated for illustrative purposes.

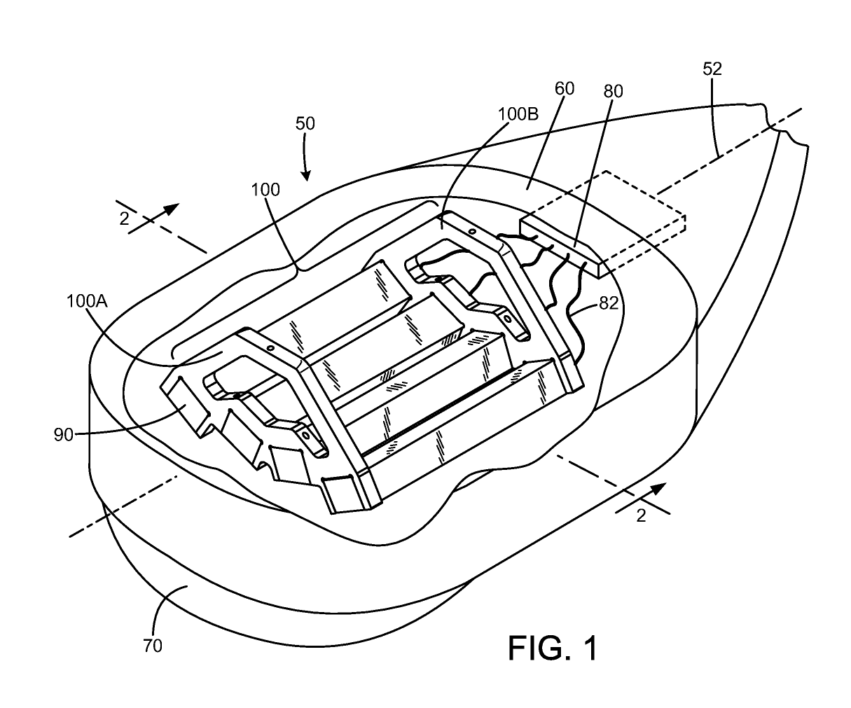

An exemplary embodiment of a light head unit 50 is illustrated in FIG. 1. This example is of a streetlight head, and takes the form of a “cobra head” style of fixture, but the subject matter disclosed herein may be employed in other types and forms of streetlight and lighting fixtures as well. The streetlight head 50 includes a housing structure 60, and a lens or transparent window 70, through which light emitted by the head light source is passed. The head further includes an electrical module 80, and a plurality of LED modules 90, connected to the electrical module 80 by wiring 82 to provide electrical power to the LED light sources.

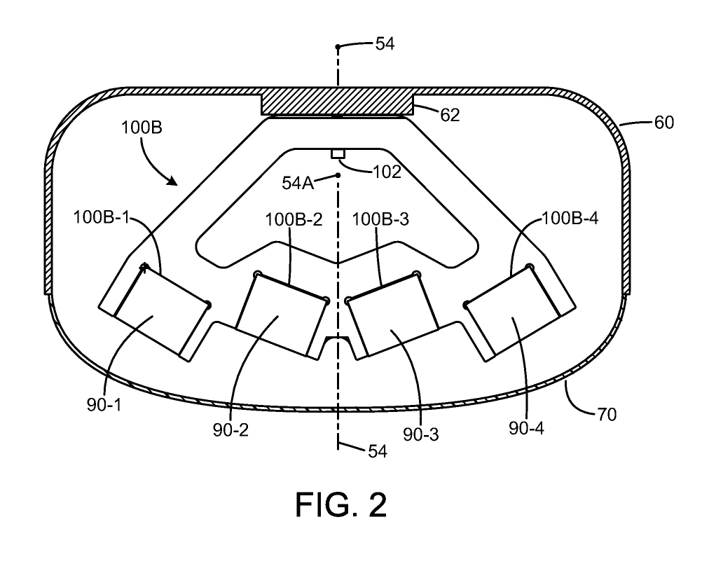

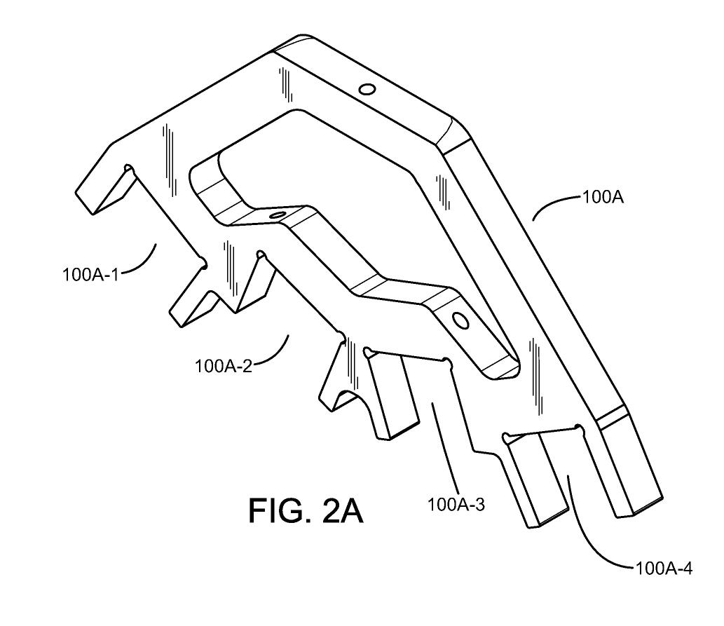

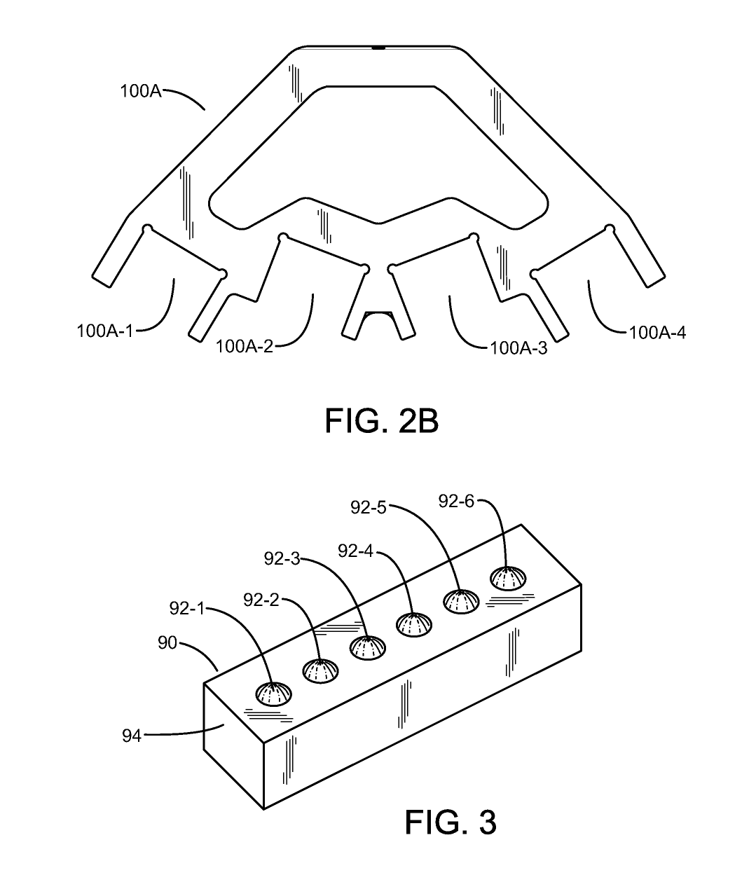

The LED modules 90 in this exemplary embodiment take the form of elongated strips, and are mounted in a bracket system 100 which fixes in respective aligned positions to provide a desired illumination pattern for the streetlight head. The bracket system 100 in this exemplary embodiment includes two bracket structures 100A and 100B, which are respectively secured to the housing 60 in spaced relation, e.g. by threaded fasteners 102, rivets, adhesives, welding, brazing, or soldering. The bracket structures may be mounted directly to the housing 60, or to a mount rib 62 (FIG. 2) extending along the top of the housing in general alignment to the longitudinal axis 52 of the head. The bracket structures may be spaced apart so as to provide respective mounting locations for attachment of the respective ends of the LED modules 90. The bracket structures may be fabricated of metal or a non-conductive material such as a plastic. One exemplary material suitable for use in the bracket structures is an aluminum alloy, with zinc and magnesium, to act as a heat conductor or heat sink.

Each bracket structure 100A, 100B includes a plurality of mount locations, each configured as a mount socket in this embodiment to receive a portion of an LED module. Thus, for example, in the case in which the head includes four LED modules 90-1, 90-2, 90-3 and 90-4, each bracket structure will include at least four mount sockets. FIG. 2 diagrammatically illustrates bracket structure 100B, which defines mount sockets 100B-1, 100B-2, 100B-3 and 100B-4, which respectively receive portions of the LED modules 90-1, 90-2, 90-3 and 90-4. The sockets are angularly offset relative to the lateral center line 54 of the head 50, so as to increase the angular size of the head illumination pattern. The angular offsets may be selected to meet the requirements of a particular application. For example, a head mounted for use on a 30 foot pole for a highway application may utilize a larger angular offset of the outer modules to increase the illumination footprint. A head mounted for use on a city street on a 25 foot pole or height may utilize a smaller angular offset of the outer modules than that used for a highway application. A head mounted for use on a residential street on an 18 foot pole may utilize an even smaller angular offset of the outer two modules relative to that utilized in the highway application. For one exemplary embodiment, the angular offsets of the inner two modules may be the same for all three applications, i.e. highway, city street and residential street applications, while the angular offset of the outer two modules may be different for each of these three applications. This offset configuration may allow the desired illumination pattern to be achieved, without requiring a relatively large radius of the socket arrangement, thereby allowing the face of the lens 70 to be relatively flat on the underside of the head.

FIGS. 2A and 2B show the forward bracket structure 100A in isolation, with mount sockets 100A-1, 100A-2, 100A-3 and 100A-4. With the forward and aft bracket structures 100A, 100B mounted in the housing 60 in alignment along longitudinal axis 54, the bracket structure provide aligned respective module sockets, e.g. 100A-1 and 100B-1, to similarly mount the respective LED modules in general parallel alignment with the axis 54. Each socket in this exemplary embodiment is in the form of a U-shaped channel, and has a base surface and opposed wall surfaces to provide secure mounting of the LED module.

An exemplary LED module 90 is illustrated in FIG. 3 in further detail. In this exemplary embodiment, each module or light bar includes an array of LEDs 90-1, 90-2, 90-3, 90-4, 90-5 and 90-6. For one exemplary embodiment, each LED is a 3 watt LED mounted with a small reflector, and in a generally linear array configuration. Although the exemplary embodiment of FIG. 3 shows six LEDS in each array, for other embodiments, a greater or fewer number of LEDS may be employed, for example eight or ten LEDS per array. The LEDs may be mounted on a circuit board, directly mounted to the bracket socket by threaded fasteners, or to a housing structure 94, in turn mounted to the bracket socket. The LED modules are preferably mounted to the sockets by means suitable for ready removal, to allow the modules to be replaced. For example, the LED modules may be attached by clips or threaded fasteners to the mount sockets in the bracket structures. The wiring connections from the electrical module 80 to the modules may be by connectors or clips, thereby facilitating the installation of the modules in the head. Moreover, each module may be separately replaced after installation, in the event a particular module becomes damaged or inoperable. This can provide significant cost savings, since damage or inoperability of one module can be addressed by replacement of the damaged or inoperable module, without requiring replacement of the entire head or LED package.

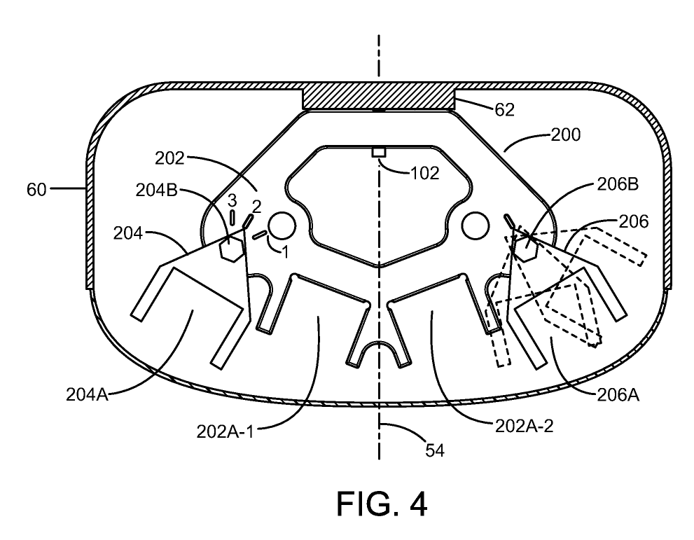

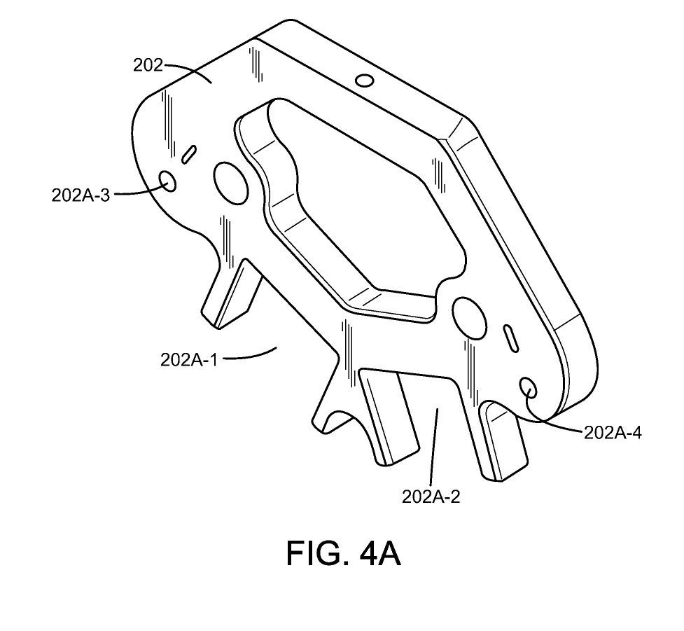

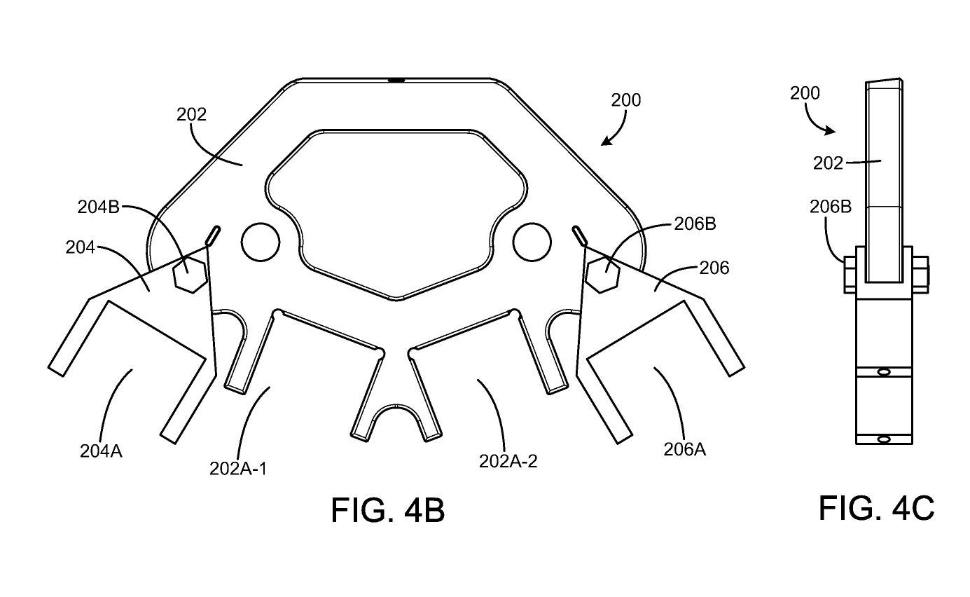

FIGS. 4 and 4A-4D illustrate an alternate embodiment of a bracket structure 200, which may be used in place of each of the bracket structures 100A, 1008. In contrast to the fixed positions of the LED module sockets in the bracket structures 100A, 1008, the bracket structure 200 provide adjustability in the angular positioning of the outer sockets. This feature enables the illumination profile or envelope of the lighting head to be adjusted, allowing the illumination created by the lighting head to be broadened or narrowed.

The bracket structure 200 in an exemplary embodiment includes a primary web bracket structure 202, which is secured to a mount rib 62, e.g. by a threaded fastener 102. The primary structure 202 defines two fixed interior LED module mount locations or sockets 202A1, 202A2, each angularly oriented at an offset angle relative to the center axis 43. The bracket structure 200 further includes two pivot bracket structures 204, 206, which are pivotally mounted to the primary structure 202 by fasteners 204B, 206B, respectively, extending through openings 202A-3 and 202A-4 in the primary bracket 202. Each sub-bracket structure 204, 206 defines a respective LED module socket 204A, 206A. As shown in phantom regarding exemplary pivot bracket structure 206, the operating position of the pivot brackets can be put to any of a range of angular orientations within a range of movement, by pivoting about the corresponding fastener (206B for structure 206). The fasteners may be threaded fasteners, e.g. nut and bolt, which pass through an opening in the primary structure. In a loosened condition, the fasteners permit rotation of the pivot bracket structures to allow positioning to any desired angular orientation within a range of movement, at which the fasteners may be tightened to fix the position of the pivot bracket structure at the desired orientation. In other embodiments, the fastener opening in the primary structure may be a slotted opening, to allow linear as well as angular adjustment of the position of the pivot bracket structure. In other embodiments, the adjustment may be to a discrete set of positions within the range of movement. The position of a given number of predetermined discrete positions may be marked or indicated on the bracket structure, e.g. as shown in FIG. 4 by alignment marks 1, 2 and 3 on bracket 202. Each of these marks may correspond to a particular application for the head, e.g. position 1 for highway use, position 2 for city streetlight use, and position 3 for residential streetlight use.

In the exemplary embodiment of FIGS. 4-4D, the pivot bracket structures each define a single LED module socket. In other embodiments the pivot bracket structure may define two or more module sockets. Also, for other embodiments, the primary bracket structure may define more than two fixed sockets, or fewer or none.

As with the embodiment illustrated in FIG. 1, two of the bracket structures 200 may be deployed at fore and aft locations along the longitudinal axis of the lighting head, and the LED modules connected in the respective sockets. By appropriate adjustment of the pivot bracket structures, a desired illumination pattern of the head may be obtained. By adjusting the bracket structures so that the angle between the vertical axis of the head and the outer socket position is reduced, the illumination pattern will be more narrowly defined, than if the bracket structures are adjusted to provide a larger angle between the vertical axis and the socket position.

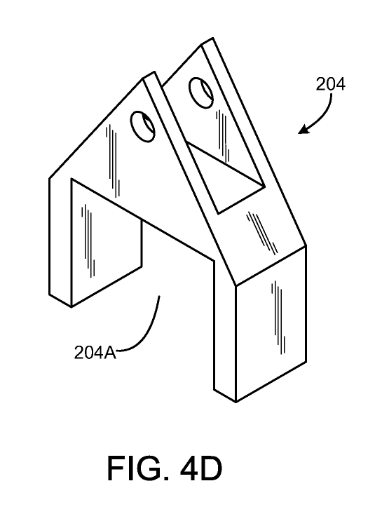

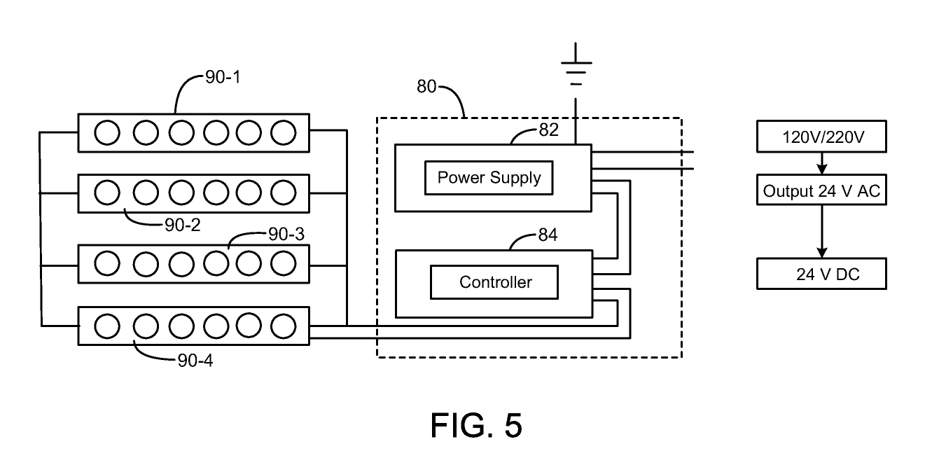

FIG. 5 is a simplified exemplary electrical schematic diagram for the head systems of FIGS. 1-4D. The electrical module 80 in this example includes a power supply 82, which is connected to a source of AC line voltage, at 120V or 220V, and provides a low voltage AC output at 24 VAC. The power supply output is in turn connected to the controller 84, which converts the low AC voltage supply to a low DC voltage, e.g. 24 VDC, to power the LED modules 90-1, 90-2, 90-3 and 90-4. The controller 84 may include a photocell to limit the time of operation of the streetlight to darkness hours, or may respond to commands from an external controller, or may include a timer set to control the time period of operation in which power is applied to the lighting sources, the LED modules.

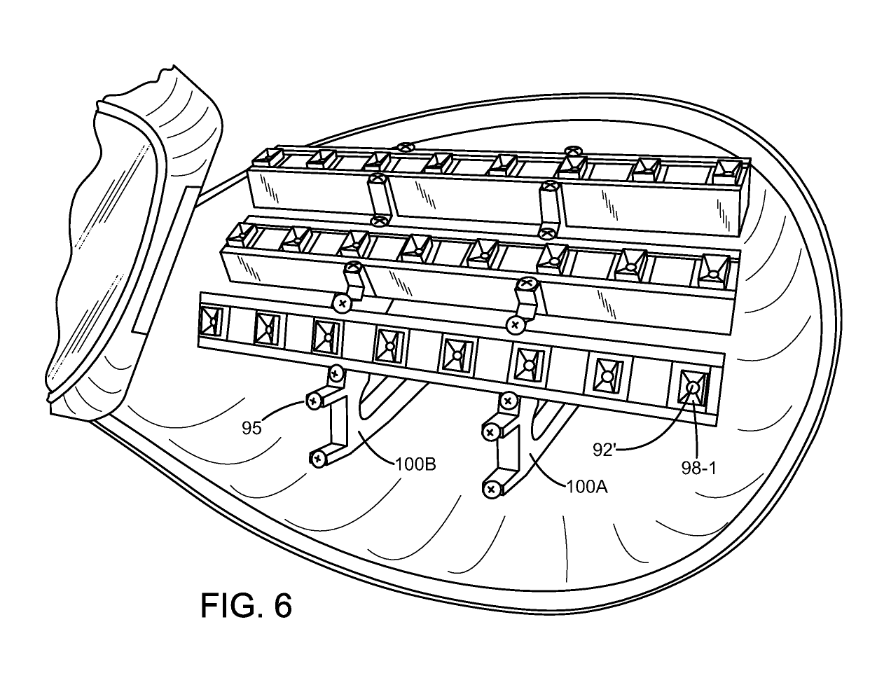

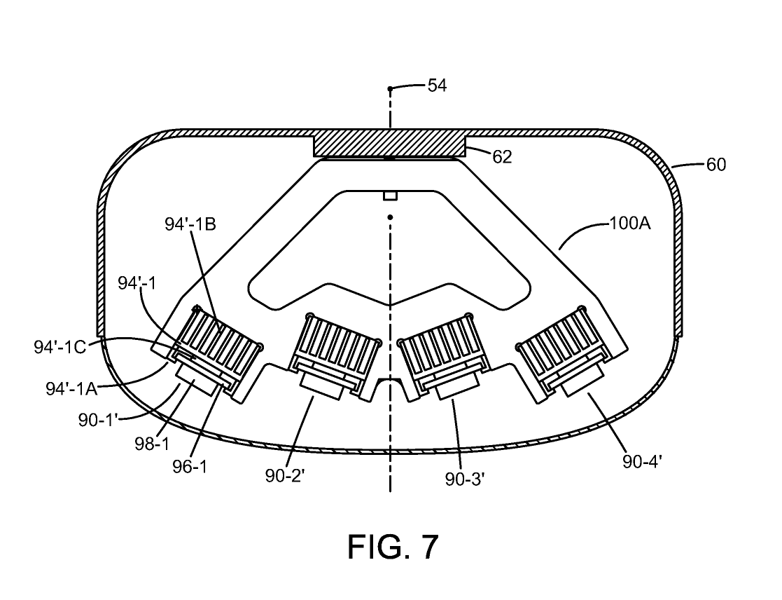

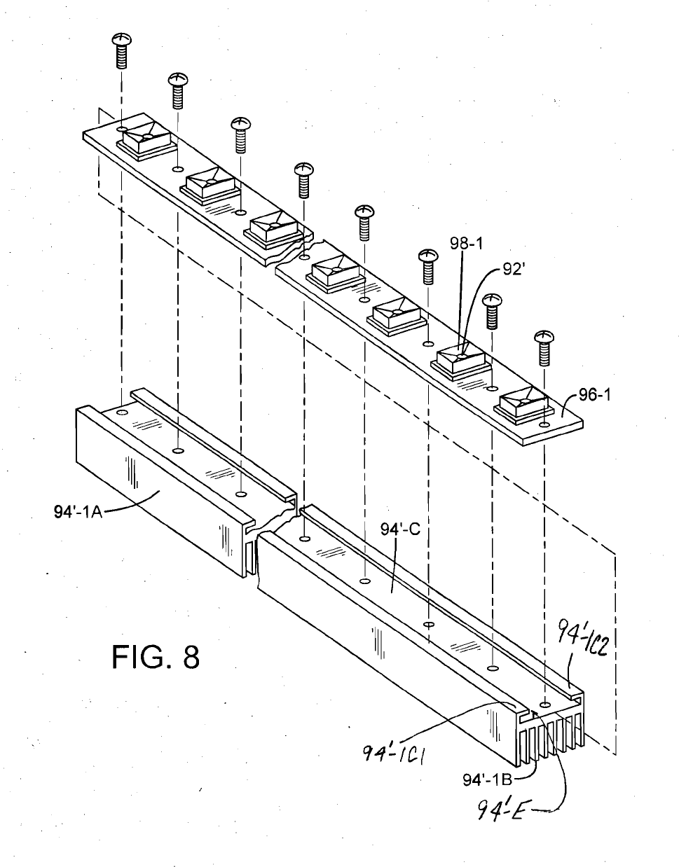

FIGS. 6-8 illustrate another embodiment of a streetlight head, in which each LED module includes eight LEDS disposed in a generally linear configuration, mounted on a printed wiring board, in turn mounted to a heat sink housing. In this embodiment, the heat sink housing is a unitary structure, fabricated of aluminum or the like, including a base or platform portion for mounting a printed wiring board carrying the LEDS thereon, and a set of cooling fins, to form a heat sink. Thus, for example, as shown in FIGS. 7-8, the heat sink housing 94′-1A includes platform portion 94′-C on which the printed wiring board 96-1 is mounted, and a set of cooling fins 94′-1B. The heat sink housing in this embodiment further has right angle tab portions 94′-1C1 and 94′-1C2 extending above surface 94′-C to form a channel 94′-E. The wiring board 96′1 may be sized to slide into the channel from an end of the heat sink housing to its operating position, or may be narrower than the open end of the channel. The printed wiring board has mounted thereon in spaced relation eight 3 watt LEDs 92′ each with its own associated minireflector 98-1.

Fasteners 95 are used to mount the respective modules to the brackets 100A and 100B. The fasteners are preferably removable to allow each module to be replaced independently of the other modules. The wiring connections may be by connectors or terminal clips, allowing the electrical connections to be disconnected and reconnected to replace a given module in the field.

The modules with heat sink housings 94′-1 provide a significant cooling feature to conduct heat generated by LED operation away from the LEDS. The head housing may be provided with louvers or slots, to allow some air movement. The brackets 100A and 100B provide a mounting arrangement that is relatively open, to increase air flow within the head in the region around the LED modules.

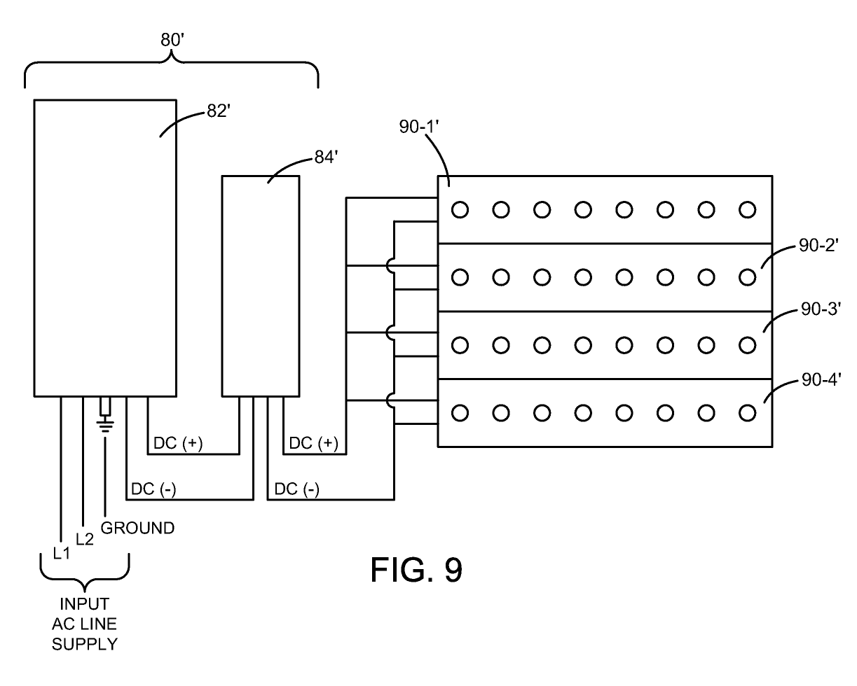

FIG. 9 is a simplified exemplary alternate electrical schematic diagram for an LED lighting system such as that illustrated in FIGS. 6-8. The electrical module 80′ in this example includes a power supply 82′, which is connected to a source of AC line voltage, at 120V or 220V, and provides a low voltage DC output at nominal 27V. A power supply suitable for the purpose is the Mean Well S-150-27 power supply, by way of example only. The power supply output is in turn connected to the controller 84, which controls application of the DC supply to the LED modules 90-1′, 90-2′, 90-3′ and 90-4′. The controller 84 may include a photocell to limit the time of operation of the streetlight to darkness hours, or may respond to commands from an external controller, or may include a timer set to control the time period of operation in which power is applied to the lighting sources, the LED modules. The LEDs in each module may be connected in parallel, and two wiring connections, plus and minus, are connected from the power supply to each module.

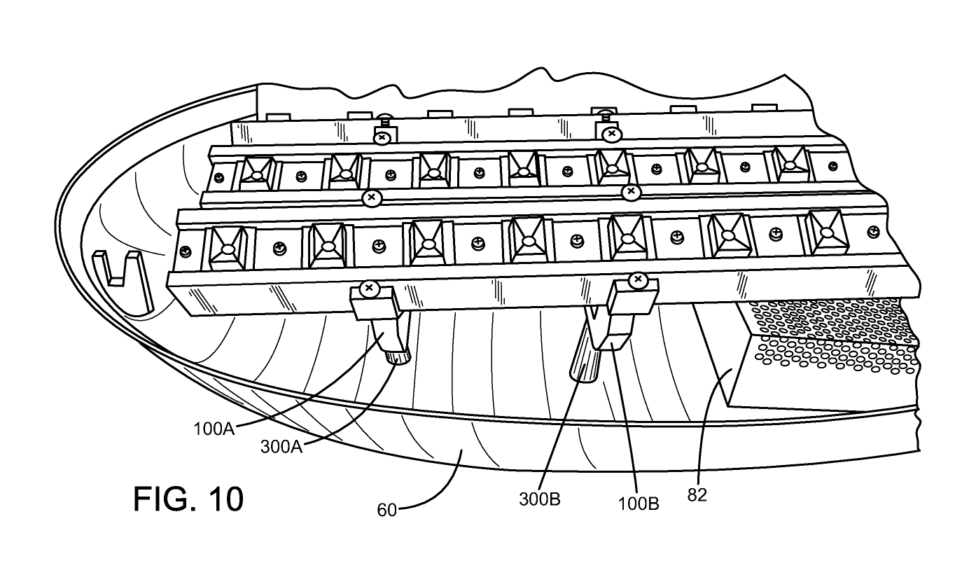

The forward and aft bracket structures 100 or 200 may be mounted to the housing 60 by standoff bosses as illustrated in FIG. 10. FIG. 10 illustrates standoff bosses 300A and 300B, having one end secured to the housing 60, and an opposed end secured to the respective bracket structures, in this example 100A and 1008. The standoff bosses may be integrally formed with the housing, or secured to the housing by threaded fasteners or rivets. The bosses 300A and 300B may be of different heights, to orient the LED modules at an angle relative to the longitudinal axis of the head. This may serve to elevate the rear end of the light modules above the housing of the power supply 82, and also direct the lighting field to a desired direction.

Although the foregoing has been a description and illustration of specific embodiments of the subject matter, various modifications and changes thereto can be made by persons skilled in the art without departing from the scope and spirit of the invention.

What is claimed is:

1. A light system, comprising:
a housing structure;
a light source comprising a plurality of separate light emitting diode (LED) modules;
a lens or transparent window in the housing structure, through which light emitted by the light source is passed;
a bracket system configured to fix the plurality of LED modules in respective aligned positions to provide a desired illumination pattern, including a bracket structure, secured to the housing so as to provide a plurality of mounting locations for attachment of the LED modules.

2. The system of claim 1, wherein the bracket system includes first and second bracket structures, respectively secured to the housing in spaced relation, and wherein opposed end regions of the plurality of LED modules are secured to the respective first and second bracket structures.

3. The system of claim 1, wherein each of said LED modules comprises a plurality of LEDs arranged in a generally linear arrangement.

4. The system of claim 1, wherein the plurality of LED modules are secured by the bracket system in parallel to each other and to a longitudinal axis of the light head system.

5. The system of claim 1, wherein the plurality of mount locations includes a first pair of mount locations disposed at substantially equal angular offsets from, and on opposite sides of, a vertical axis associated with the light head system.

6. The system of claim 5, wherein the plurality of mount locations includes a second pair of mount locations disposed at substantially equal angular offsets from and on opposite sides of the vertical axis, and outwardly of the first pair of mount locations.

7. The system of claim 1, wherein the plurality of mount locations are fixed.

8. The system of claim 1, wherein a set of the plurality of mount locations are movable within a range of motion to allow an illumination pattern of the system to be adjusted.

9. The system of claim 8, wherein the bracket system includes a primary bracket structure defining a first set of mount locations, and at least one pivot bracket structure pivotally attached to the primary bracket structure and defining a pivot bracket mount location for attachment of a portion of an LED module, and a fastener member for securing the pivot bracket to any one of a plurality of positions within a range of movement.

10. The system of claim 1, further comprising:
an electrical module electrically connected to the plurality of LED modules to provide electrical power to the LED modules.

11. The system of claim 1, wherein each of said LED modules includes:
an elongated printed wiring board on which a plurality of LEDs are mounted in a generally linear arrangement; and
an elongated unitary heat sink housing structure configured for mounting the printed wiring board to a heat sink mount surface portion, the heat sink housing structure further including a plurality of cooling fin portions formed below the heat sink mount surface portion in a transverse arrangement relative to the heat sink mount surface portion.

12. A streetlight head system, comprising:
a housing structure;
a light source comprising a plurality of separate light emitting diode (LED) modules disposed within the housing structure;
a lens or transparent window in the housing structure, through which light emitted by the light source is passed;
an electrical module connected to the plurality of LED modules to provide electrical power to the LED modules;
a bracket system configured to fix the plurality of LED modules in respective aligned positions to provide a desired illumination pattern, said bracket system including first and second bracket structures, respectively secured to the housing in spaced relation so as to provide respective mounting locations for attachment of respective ends of the LED modules, said mounting locations including a plurality of mount sockets.

13. The system of claim 12, wherein each of said LED modules comprises a plurality of LEDs arranged in a generally linear arrangement.

14. The system of claim 12, wherein the plurality of LED modules are secured by the bracket system in parallel to each other and to a longitudinal axis of the streetlight head system.

15. The system of claim 12, wherein the plurality of mount locations includes a first pair of mount locations disposed at substantially equal angular offsets from, and on opposite sides of, a vertical axis associated with the streetlight head system.

16. The system of claim 12, wherein the plurality of mount locations includes a first pair of mount locations disposed at substantially equal angular offsets from, and on opposite sides of, a vertical axis associated with the streetlight head system.

17. The system of claim 16, wherein the plurality of mount locations includes a second pair of mount locations disposed at substantially equal angular offsets from and on opposite sides of the vertical axis, and outwardly of the first pair of mount locations.

18. The system of claim 12, wherein the plurality of mount locations are fixed.

19. The system of claim 12, wherein a set of the plurality of mount locations are movable within a range of motion to allow an illumination pattern of the system to be adjusted.

20. The system of claim 19, wherein each of the bracket structures includes a primary bracket structure defining a first set of mount locations, and at least one pivot bracket structure pivotally attached to the primary bracket structure and defining a pivot bracket mount location for attachment of a portion of an LED module, and a fastener member for securing the pivot bracket to any one of a plurality of positions within a range of movement.

21. The system of claim 1, wherein each of said LED modules includes:
an elongated printed wiring board on which a plurality of LEDs are mounted in a generally linear arrangement; and
an elongated unitary heat sink housing structure configured for mounting the printed wiring board to a heat sink mount surface portion, the heat sink housing structure further including a plurality of cooling fin portions formed below the heat sink mount surface portion in a transverse arrangement relative to the heat sink mount surface portion.

22. A heat sink housing for a light emitting diode (LED) module, the module including an elongated printed wiring board on which a plurality of LEDs are mounted in a generally linear arrangement, the heat sink housing comprising:
an elongated unitary heat sink housing structure configured for mounting the printed wiring board to a planar heat sink mount surface portion, the heat sink housing structure further including a plurality of cooling fin portions formed below and in a unitary structure with the heat sink mount surface portion in a transverse arrangement relative to the heat sink mount surface portion to conduct heat away from the LEDs and printed wiring board generated during operation of the LEDs.

23. The housing of claim 22, wherein the heat sink housing structure is a one piece structure fabricated from aluminum.

24. The housing of claim 22, wherein the heat sink housing structure further includes:
first and second elongated right angle tab portions extending above said heat sink mount surface portions to form a channel.

25. The housing of claim 24, wherein the tab portions and the channel is configured to mount the printed wiring board within the channel.
